(19) United States
(12) Patent Application Publication
(10) Pub. No.: US 2024/0072378 A1
(43) Pub. Date: Feb. 29, 2024

(54) TRACTION BATTERY ASSEMBLY HAVING MULTIPIECE BUSBAR MODULE

(71) Applicant: FORD MOTOR COMPANY, Dearborn, MI (US)

(72) Inventors: Paul John Bojanowski, Macomb Township, MI (US); Brian Utley, Canton, MI (US); Michael Orr, Ferndale, MI (US)

(21) Appl. No.: 17/896,727

(22) Filed: Aug. 26, 2022

(51) Int. Cl. H01M 50/507; H01M 50/211; H01M 50/296; H01M 50/516

(52) U.S. Cl. CPC H01M 50/507; H01M 50/211; H01M 50/296; H01M 50/516; H01M 50/249; H01M 2220/20

(57) ABSTRACT

A traction battery includes a battery array having a stack of cells, wherein a first of the cells includes a terminal having a projecting portion extending from a body of the cell and a curved portion disposed on a distal end of the projecting portion. A busbar has a connecting portion defining a slot with a pair of first opposing sides and a pair of second opposing sides. The connecting portion further has a pair of flaps, each pivotally attached to one of the second opposing sides such that the flaps oppose each other. The terminal is mechanically joined to the connecting portion with the curved portion of the terminal in contact with at least one of the flaps.

### TECHNICAL FIELD

The present disclosure relates to traction battery assemblies for motor vehicles, and more specifically to traction battery assemblies having multipiece busbar modules.

### BACKGROUND

Vehicles such as battery-electric vehicles and hybrid-electric vehicles contain a traction battery assembly to act as an energy source for the vehicle. The traction battery may include components and systems to assist in managing vehicle performance and operations. The traction battery may also include high-voltage components, and may include an air or liquid thermal-management system to control the temperature of the battery.

### SUMMARY

According to one embodiment, a traction battery includes a stack of cells, wherein a first of the cells includes a terminal having a projecting portion extending from a body of the cell and a curved portion disposed on a distal end of the projecting portion. A busbar has a connecting portion defining a slot with a pair of first opposing sides and a pair of second opposing sides. The connecting portion further has a pair of flaps, each pivotally attached to one of the second opposing sides such that the flaps oppose each other. The terminal is mechanically joined to the connecting portion with the curved portion of the terminal in contact with at least one of the flaps.

According to another embodiment, a traction battery includes a plurality of stacked cells that each have at least one terminal with a curved end portion. The battery further includes busbars electrically interconnecting the cells. Each of the busbars has a connecting portion having a slot with a pair of first opposing sides and a pair of second opposing sides. The connecting portion further have a pair of flaps, each pivotally attached to one of the second opposing sides such that the flaps oppose each other. The terminals are mechanically joined to associated ones of the connecting portions with the curved portions in contact with associated ones of the flaps.

According to yet another embodiment, a traction battery includes a battery array having a plurality of cells, wherein a first of the cells includes a terminal having a curved portion. The battery further includes a busbar having a main body with opposed top and bottom surfaces and a pair of flaps angled relative to the main body and each having a top surface and a bottom surface. The curved portion extends through the busbar such that a first area of the curved portion is in contact with the top surface of one of the flaps and a second area of the curved portion is in contact with the bottom surface of the other of the flaps.

### BRIEF DESCRIPTION OF THE DRAWINGS

FIG. 1 is a schematic diagram of an example hybrid vehicle.

FIG. 2 is a perspective view of a traction battery assembly.

FIG. 3 is a perspective view of a battery cell.

FIG. 4A is an exploded perspective view of a busbar being attached to a terminal of a battery cell.

FIG. 4B is a perspective view of the busbar attached to the terminal of the battery cell.

FIG. 5A is a perspective view of a busbar attached to a terminal of the battery cell according to alternative embodiment.

FIG. 5B shows an alternative weld for the embodiment of FIG. 5A.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

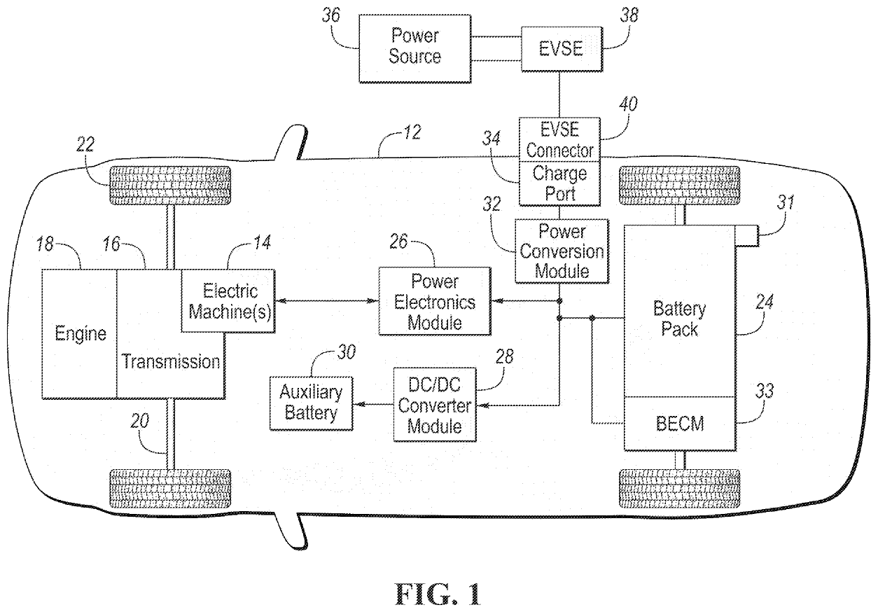

FIG. 1 depicts a schematic of a plug-in hybrid-electric vehicle (PHEV). Certain embodiments, however, may also be implemented within the context of non-plug-in hybrids and fully electric vehicles. The vehicle 12 includes one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy through regenerative braking. The electric machines 14 reduce pollutant emissions and increase fuel economy by reducing the work load of the engine 18.

A traction battery or battery pack 24 stores energy that can be used by the electric machines 14. The traction battery 24 typically provides a high voltage direct current (DC) output from one or more battery cell arrays, sometimes referred to as battery cell stacks, within the traction battery 24. The battery cell arrays include one or more battery cells.

The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle.

Different battery pack configurations may be available to address individual vehicle variables including packaging constraints and power requirements. The battery cells may be thermally regulated with a thermal management system. Examples of thermal management systems include: air cooling systems, liquid cooling systems, and a combination of air and liquid systems.

The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to fully electric vehicles. In a fully electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as compressors and electric heaters, may be connected directly to the high-voltage supply without the use of a DC/DC converter module 28. In a typical vehicle, the low-voltage systems are electrically connected to an auxiliary battery 30, e.g., a 12-volt battery.

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by a charging station connected to an external power source 36. The external power source 36 may be electrically connected to electric vehicle supply equipment (EVSE) 38. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus, e.g., Controller Area Network (CAN), or via dedicated electrical conduits.

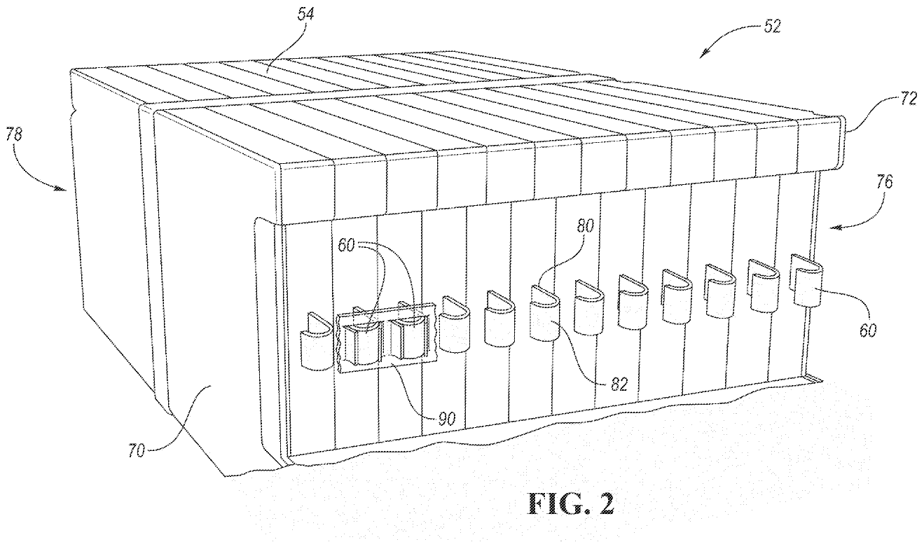

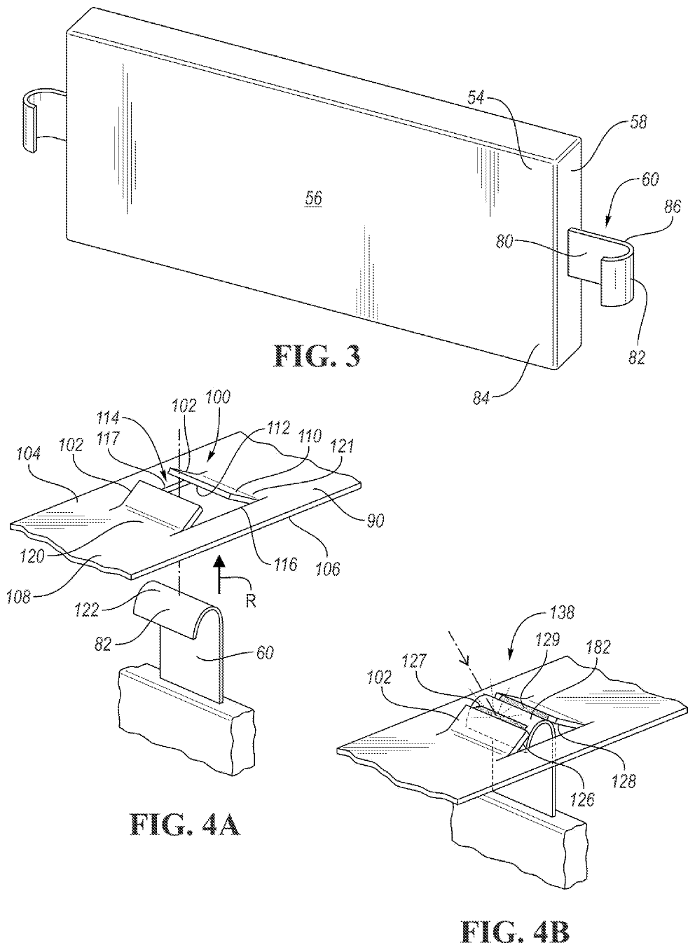

Referring to FIGS. 2 and 3, the traction battery assembly 24 includes one or more battery arrays 52 each having a plurality of battery cells 54 arranged in stack. It is to be understood that the battery 24 may include one, two, three, four, or more arrays or stacks of cells.

Each of the battery cells 54 may have opposing major sides 56. The cells may be pouch cells. Terminals 60 extend from the minor sides 58. Each cell 54 may have two terminals 60, e.g., a positive terminal and a negative terminal, with the positive and negative terminals extending from a different minor side 58. (In other embodiments, the terminals may be located on a same minor side.)

The array 52 may be held together by a pair of endplates 70, 72 and rails or other tension members (not shown) that connect the endplates to provide compression and retention of the cells. Each endplate 70, 72 is adjacent to a major side 56 of the first or last cell. The arrays 52 may include additional support structure, spacers, or cooling features as known in the art. The traction battery 24 may include more or less of the above-described battery arrays 52 depending upon the power requirements, packaging constraints, the desired electric range of the vehicle, and other factors.

The battery array 52 includes at least one terminal side, i.e., the side(s) from which the terminals extend. In the illustrated embodiment, the battery array 52 has a pair of opposing terminal sides 76, 78. The cells 54 in each array 52 may be wired in series, parallel, or a combination thereof. When more than one array is provided, the array may be connected in in series, parallel, or a combination thereof.

One or more of the terminals 60 may have a projecting portion 80 extending from a body 84 of the cell 54 and a curved portion 82 disposed on a distal end 86 of the projecting portion 80. The projecting portion 80 may be a straight segment of the terminal 60. The projecting portion 80 and the curved portion 82 may be integrally formed with each other. For example, the terminal may be strip of metal that is bent to have the projecting portion 80 and the curved portion 82. The terminal may be copper, aluminum, or other electrically conductive material.

The battery cells 54 of each array 52 are electrically connected to each other with one or more busbars 90. Only a portion of a single busbar is shown for illustrative purposes. But, in actuality, each of the terminals will be connected to either the shown busbar or another busbar, which may be the same as the shown busbar. The busbar(s) 90 electrically connect two or more battery cells. For example, the busbar 90 may electrically connect adjacent battery cells in series. Alternatively, a busbar may electrically connect two or more battery cells in parallel. In some embodiments, some of the busbars may connect cells in parallel where is other busbars connect cells in series. For example, a plurality of first busbars may connect two or more cells in parallel and a plurality of second busbars may connected the first busbars in series. These, of course, are just examples and this application is not limited to any particular busbar arrangement.

Referring to FIGS. 4A and 4B, an example busbar 90 is joined to an example terminal 60. The busbar 90 includes a connecting portion 100 configured to join with the terminal 60. The connecting portion 100 includes one or more angled surfaces arranged to engage with the curved portion 82 of the terminal 60. The angled surfaces may be formed on flaps or tabs 102 of the busbar 90.

The busbar 90 may include a main body 108 having a top surface 104 and bottom surface 106. The flaps 102 may be angled upwardly relative to the top surface 104 to form an angled top surface 110 and an angled bottom surface 112. In the illustrated embodiment, each connecting portion 100 includes a pair of tabs 102 that are angled opposite each other. A slot 114 is located between the flaps 102. The slot 114 may be generally rectangular having first opposing sides 116, 117 orthogonal to the flaps 102. The connecting portion 100 may be formed by cutting the sides 116, 117 of the slot 114, cutting a midline orthogonal to the opposing sides to create the flaps 102, and then folding the flaps 102 upwardly from the top surface 104 to the position shown in FIG. 4A. In this way, the flaps 102 are pivotally attached to second opposing sides 120, 121 of the slot 114. The radius (R) of the curved portion, the spacing between the flaps 102, and the angles of the flaps are designed so that the bottom surfaces 112 of the flaps 102 engage with an outer arcuate surface 122 of the curved portion. The flaps 102 may be angled the same relative to the top surface 104 of the busbar or may be angled differently relative to the top surface 104.

The flaps 102 may be integrally formed with the main body 108 of the busbar 90 or, alternatively, may be a second component that is joined to the main body 108 of the busbar. In some embodiments, the thickness of the main body 108, i.e., between the top and bottom surfaces 104/106, may be greater than the thicknesses of the flaps 102. This may aid in the bendability of the flaps 102.

In the illustrated embodiment, the terminal 60 is connected to the busbar 90 by inserting curved portion 82 at least partially through the slot 114. This places the outer surface 122 of the curved portion 82 in contact with the bottom surfaces 112 of the flaps 102. The outer surface 122 is then joined to the flaps 102. For example, a first segment 126 of the curved portion 82 is joined to a first of the flaps 102 and a second segment 128 of the curved portion is joined to the second of the flaps. The busbar 90 may be joined to the terminal 60 by welding 127, 129, such as laser welding. For example, a fillet-type weld or a lap-type weld may be used.

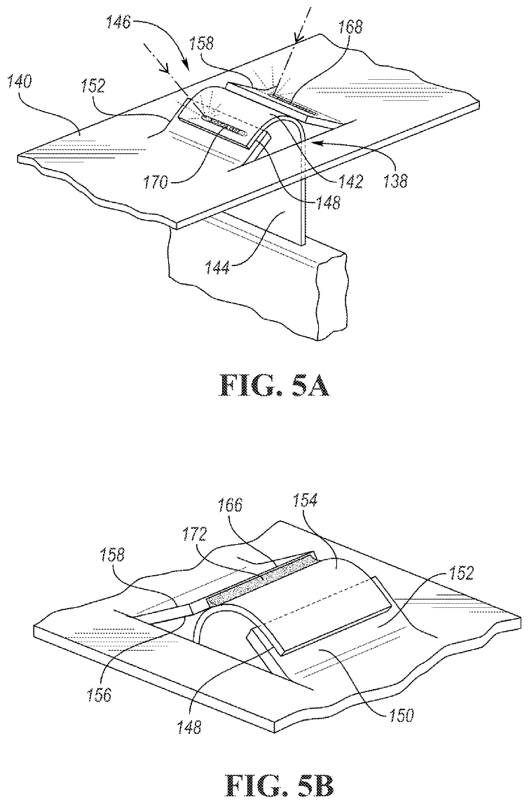

FIGS. 5A and 5B illustrate a different way of connecting a busbar with a terminal. The structure of connecting portion 138 of the busbar 140 and the curved portion 142 of the terminal 144 may be the same or similar to the above-described busbars and terminals; however, slight variations may be present to facilitate the different connection of this embodiment. Here, the curved portion 142 extends through the slot 146 such that an inner surface 148 of the curved portion 142 engages a top surface 150 of the flap 152 and an outer surface 154 of the curved portion 142 engages with a bottom surface 156 of the second flap 158. To facilitate this the flaps 152, 158 may be angled differently. For example, the angle of the flap 158 relative to the top surface 160 of the busbar 140 may be greater than the angle of the flap 152 relative to the top surface 160—i.e., the flap 158 is bent up more than the flap 152. The terminal 144 may be joined to the busbar 140 by welding, such as laser welding. The welding may be fillet-type, lap-type, or combination thereof. For example, the flap 158 may be joined to the curved portion 142 by a lap-type weld 168 and the flap 152 may be joined to the curved portion 142 by a lap weld 170. The lap weld 170 may be applied at the overlapping area between the curved portion 142 and the flap 152 to join the inner surface 148 of the terminal to the top surface 150 of the tab 152.

Alternatively, as shown in FIG. 5B, the flap 158 may be joined to the terminal by a filet-type weld 172 that may extend along an upper edge 166 of the flap 158 to join the outer surface 154 of the terminal with the flap 158. The lap weld 170 may again be used in the embodiment, of the lap weld 170 may be replaces with a filet weld or the like.

Each of the busbars includes one or more of the connecting portions according to the one or more embodiments discussed above. In some embodiments, each busbar may include a pair of connecting portions, e.g., connecting portion 100 or connecting portion 138, that each connect to a terminal of a different cell. The connections of the busbar may all be according to the same design, e.g., two connecting portions 100. Alternatively, the busbar may connect to a first cell terminal according to the embodiment of FIG. 4 and may connect to a second cell terminal according to the embodiments of FIG. 5.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A traction battery comprising:
a stack of battery cells, wherein a first of the cells includes a terminal having a projecting portion extending from a body of the cell and a curved portion disposed on a distal end of the projecting portion; and
a busbar including a connecting portion having a slot with a pair of first opposing sides and a pair of second opposing sides, the connecting portion further having a pair of flaps, each pivotally attached to one of the second opposing sides such that the flaps oppose each other; wherein
the terminal is mechanically joined to the connecting portion with the curved portion of the terminal in contact with at least one of the flaps.

2. The traction battery of claim 1, wherein the curved portion is in contact with both of the flaps.

3. The traction battery of claim 1, wherein the busbar includes a top surface and a bottom surface, and the flaps are pivotal to extend upwardly from the top surface.

4. The traction battery of claim 3, wherein each of the flaps includes a top surface and a bottom surface, wherein the curved portion is in contact with both of the bottom surfaces of the flaps.

5. The traction battery of claim 3, wherein each of the flaps includes a top surface and a bottom surface, wherein the curved portion is in contact with the top surface of one the flaps.

6. The traction battery of claim 3, wherein each of the flaps includes a top surface and a bottom surface, wherein the curved portion is in contact with the bottom surface of one of the flaps and the top surface of the other of the flaps.

7. The traction battery of claim 1, wherein the projecting portion is straight.

8. The traction battery of claim 1, wherein a thickness of the flaps is less than a thickness of a body of the busbar.

9. The traction battery of claim 1, wherein a second of the cells includes a second terminal having a second projecting portion extending from a body of the second cell and a second curved portion disposed on a distal end of the second projecting portion, wherein the busbar further includes a second connecting portion having a second slot with a pair of first opposing sides and a pair of second opposing sides, the connecting portion further having a second pair of flaps, each pivotally attached to one of the second opposing sides of the second connecting portion such that the second flaps oppose each other, wherein the second terminal is mechanically joined to the second connecting portion with the second curved portion of the second terminal in contact with at least one of the second flaps.

10. The traction battery of claim 9, wherein the second connecting portion includes a top surface and a bottom surface, and the second flaps are pivotal to extend upwardly from the top surface of the second busbar.

11. The traction battery of claim 10, wherein each of the second flaps includes a top surface and a bottom surface, wherein the second curved portion is in contact with both of the bottom surfaces of the second flaps.

12. The traction battery of claim 10, wherein each of the second flaps includes a top surface and a bottom surface, wherein the second curved portion is in contact with the top surface of one the second flaps.

13. The traction battery of claim 1, wherein the cells are pouch cells.

14. The traction battery of claim 1, wherein the curved portion is welded to the one of the flaps.

15. A traction battery comprising:
a plurality of stacked cells that each have at least one terminal with a curved end portion; and
busbars electrically interconnecting the cells, wherein each of the busbars includes a connecting portion having a slot with a pair of first opposing sides and a pair of second opposing sides, the connecting portion further having a pair of flaps, each pivotally attached to one of the second opposing sides such that the flaps oppose each other; wherein
the terminals are mechanically joined to associated ones of the connecting portions with the curved portions in contact with associated ones of the flaps.

16. The traction battery of claim 15, wherein the curved portions are in contact with second associated ones of the flaps.

17. The traction battery of claim 16, wherein the curved portions are in contact with bottom surfaces of the associated ones of the flaps and are in contact with top surfaces of the second associated ones of the flaps.

18. The traction battery of claim 15, wherein the curved portions are welded to the associated ones of the flaps.

19. A traction battery comprising:
a plurality of cells arranged in a stack, wherein a first of the cells includes a terminal having a curved portion; and
a busbar including a main body having opposed top and bottom surfaces and a pair of flaps angled relative to the main body and each having a top surface and a bottom surface; wherein
the curved portion extends through the busbar such that a first area of the curved portion is in contact with the top surface of one of the flaps and a second area of the curved portion is in contact with the bottom surface of the other of the flaps.

20. The traction battery of claim 19, wherein the first area is welded to the top surface of one of the flaps and the second area is welded to the bottom surface of the other of the flaps.
